(19) United States
(12) Patent Application Publication
(10) Pub. No.: US 2013/0212301 A1
(43) Pub. Date: Aug. 15, 2013

(54) METHOD FOR ASSIGNING A SUBSCRIBER IDENTIFIER TO A NETWORK SUBSCRIBER, COMMUNICATION NETWORK AND NETWORK DEVICE

(71) Applicant: Kurt Bischinger, Wien (AT)

(72) Inventor: Kurt Bischinger, Wien (AT)

(73) Assignee: T-MOBILE INTERNATIONAL AUSTRIA GMBH, Wien (AT)

(21) Appl. No.: 13/880,105

(22) PCT Filed: Oct. 26, 2011
(86) PCT No.: PCT/EP2011/005392

§ 371 Date: Apr. 18, 2013

Related U.S. Application Data
(60) Provisional application No. 61/407,526, filed on Oct. 28, 2010.

(30) Foreign Application Priority Data
Oct. 28, 2010 (EP) 10014073.0

(51) Int. Cl. H04L 29/12

(52) U.S. Cl. CPC H04L 61/20
USPC 709/245

(57) ABSTRACT

A method for using a subscriber identifier for addressing a network subscriber in a communication network includes: combining, within the subscriber identifier, a number of binary coded decimals with at least one digit, wherein the at least one digit is a binary coded number of a higher order numbering system than the decimal numbering system.

### CROSS-REFERENCE TO RELATED APPLICATIONS

This application is a U.S. National Phase application under 35 U.S.C. §371 of International Application No. PCT/EP2011/005392, filed on Oct. 26, 2011, and claims benefit to U.S. Provisional Application No. 61/407,526, filed Oct. 28, 2010, and European Patent Application No. EP 10014073.0, filed on Oct. 28, 2010. The International Application was published in English on May 3, 2012 as WO 2012/055545 A1 under PCT Article 21(2).

### FIELD

The present invention relates to a method for assigning a subscriber identifier to a network subscriber in a communication network.

### BACKGROUND

In common telephony systems (e.g. ISDN, GSM) different numbers are used for identification, addressing and routing. The document ITU-T Rec. E.164 (February/2005) e.g. specifies the distribution of country codes as international binding standard. Even newly defined mobile communication systems such as EPS (Evolved Packet System) rely on certain numbers for identification which are defined in accordance with the international identification plan for public networks and subscription, ITU-T Rec. E.212 (May/2008), for instance. These identifiers are linked to addresses and other identifiers (e.g. IPv6 address, SIP URI) during registration in the network.

The increasing use of telephony systems and the growing number of participants leads to a shortage of numbers. This problem is compounded by upcoming machine to machine communication scenarios.

### SUMMARY

In an embodiment, the present invention provides a method for using a subscriber identifier for addressing a network subscriber in a communication network. The method includes: combining, within the subscriber identifier, a number of binary coded decimals with at least one digit, wherein the at least one digit is a binary coded number of a higher order numbering system than the decimal numbering system.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 illustrates schematically a subscriber identifier assigned to a network subscriber of a communication network by an exemplary method according to an embodiment of the present invention.

FIG. 2 illustrates schematically an exemplary architecture of a mobile network according to an embodiment of the present invention.

### DETAILED DESCRIPTION

Embodiments of the present invention provide a method for assigning a subscriber identifier to a network subscriber in a communication network and a corresponding communication network operating with specific numbers providing a higher maximum amount of different numbering combinations in order to overcome the shortage of numbers.

In an embodiment, a method is provided for assigning a subscriber identifier to a network subscriber in a communication network comprising the steps of combining a number of binary coded decimals with at least one digit to the subscriber identifier, wherein the at least one digit is a binary coded number of a higher order numbering system than the decimals numbering system, and assigning the subscriber identifier to the network subscriber.

In an embodiment, a method is provided for using a subscriber identifier for addressing a network subscriber in a communication network, wherein, within the subscriber identifier, a number of binary coded decimals are combined with at least one digit, wherein the at least one digit is a binary coded number of a higher order numbering system than the decimals numbering system.

According to the present invention, it is thereby advantageously possible to extend the existing numbering range by using higher order number systems than the decimal number system. In particular, the new numbering range is provided on top of the existing, which can be used for dedicated purposes, e.g. for machine to machine communication only. In this manner, the maximum amount of different numbers is increased, wherein simultaneously the common overall structure of numbers may still be used. Consequently, the impact of the new numbering scheme on existing protocols and equipment can advantageously be minimized. Usually numbers in conventional telephony systems are BCD (Binary Coded Decimal) numbers on the protocol level. This means that 4 bits are used to code the numbers 0 to 9. However 16 different values would be possible within 4 bits. By changing the number system from the decimal system to a higher order system—as a maximum the hexadecimal system, for instance—the unused values can be taken to extend the number range. For compatibility reasons with existing protocols and to ease the routing only a subset of the number is extended. Preferably, a binary code beyond the range of the decimal numbering system is used as the at least one digit and in particular a binary coded hexadecimal is used as the at least one digit. The binary coded decimals include values 0:0000, 1:0001, 2:0010, 3:0011, 4:0100, 5:0101, 6:0110, 7:0111, 8:1000 and 9:1001, wherein the binary coded number of the higher ordering numbering system includes the additional values 10:1010, 11:1011, 12:1100, 13:1101, 14:1110 or 15:1111, for example. Preferably, the at least one digit replaces a certain number of the (former) binary coded decimals in the new subscriber identifier and/or extends the total number of single digits of the subscriber identifier. In the hexadecimal numbering system, the at least one digit comprises the numbering range 0 to 9 and A to F (representing 0 to 15 in the decimal system), for example, wherein the conventional binary coded decimals comprises only the numbering range 0 to 9.

According to embodiments of the present invention, it is preferred that the subscriber identifier comprises a Mobile Subscriber ISDN Number (MSISDN), wherein the at least one digit is used as a part of a subscriber number of the Mobile Subscriber ISDN Number. Alternatively, the at least one digit can also be used as a part of a country code and/or of a network destination code of the Mobile Subscriber ISDN Number. In ISUP (ISDN User Part) messages the calling party number and the called party number are BCD values, which allow a maximum of only ten different values per number (e.g. 0:0000, 1:0001, 2:0010, 3:0011, 4:0100, 5:0101, 6:0110, 7:0111, 8:1000 and 9:1001). Advantageously, the maximum amount of different numbering combination is increased by combining the common BCD values with the at least one additional parameter comprising a binary coded number of the higher numbering system in the MSISDN. The digit e.g. can be designated as a letter A, B, C, D, E or F and represents e.g. one of the binary values 10:1010, 11:1011, 12:1100, 13:1101, 14:1110 or 15:1111.

Furthermore according to embodiments of the present invention, it is preferred that the subscriber identifier comprises an International Mobile Subscriber Identity (IMSI), wherein the at least one digit is used as a part of a Mobile Subscriber Identification Number (MSIN) of the International Mobile Subscriber Identity. Alternatively, the at least one digit can also be used as a part of a mobile country code and/or of a mobile network code of the International Mobile Subscriber Identity. In GSM, UMTS and LTE mobile network protocols the International Mobile Subscriber Identity as identifier for certain messages, such as location update and paging, are coded as BCD values, which allow a maximum of only ten different values per number (e.g. 0:0000, 1:0001, 2:0010, 3:0011, 4:0100, 5:0101, 6:0110, 7:0111, 8:1000 and 9:1001). Advantageously, the maximum amount of different numbering combination is increased by combining the common BCD values with the at least one additional parameter comprising a binary coded number of the higher numbering system in the IMSI. The digit e.g. can be designated as a letter A, B, C, D, E or F and represents e.g. one of the binary values 10:1010, 11:1011, 12:1100, 13:1101, 14:1110 or 15:1111.

According to embodiments of the present invention, it is furthermore preferred that the subscriber identifier is used in a MAP, ISUP and/or mobile radio interface layer 3 protocol, 3GPP TS 24.008. Advantageously, the extension of the numbering system is suitable for usage in MAP (Mobile Application Part) messages and mobile radio interface layer 3 protocol messages, so that the amount of numbers in the mobile telecommunication networks can be maximized. Advantageously, the coding is similar to the ISUP coding, so that the same number range extensions can be used on the MAP and mobile radio interface layer 3 protocol. Consequently, the addressing and routing between ISUP, MAP and mobile radio interface layer 3 protocol is comparatively simple.

According to the present invention, it is furthermore preferred that a binary code, which is registered as spare value in the used communication protocol, is used as the at least one digit. In ISUP messages, MAP messages and in mobile radio interface layer 3 messages some of the values bigger than 9 are already used for special purposes. Consequently, only a few values which are bigger than 9 are available as additional digits. These values are determined as so called “spare values” in the respective protocol specifications. Advantageously, using the spare values as the at least one digit extends the numbering system and does not detrimentally interfere other functionalities using values bigger than 9. Particularly, exactly three values of the higher order numbering system are combined to the subscriber identifier. Advantageously, the protocol specifications concerning ISUP, MAP and mobile radio interface layer 3 messages comprise at least 3 spare values which can be used as the exact three digits.

According to embodiments of the present invention, it is furthermore preferred that the method comprises a step of allocating a different binary coded number of the higher order numbering system to the at least one digit when switching from one communication protocol to another communication protocol. It is herewith advantageously possible to use different spare values in different network environments. The at least one digit represents in a first subnet of the communication network a first binary coded number of the higher numbering system, e.g. 1011, wherein the same at least one digit represents in a second subnet of the communication network a second binary coded number of the higher numbering system, e.g. 1110, which differs from the first binary coded number. This approach ensures that always the specific spare values of each communication protocol are used as the at least one digit.

The invention further relates to a communication network with at least one network subscriber, wherein a subscriber identifier is allocated to the network subscriber and wherein the subscriber identifier comprises a number of binary coded decimals, wherein the subscriber identifier comprises the at least one digit, which is a binary coded number of a higher order numbering system than the decimals numbering system. It is herewith advantageously possible to provide a communication network having a higher amount of different identification numbering schemes for the network subscriber. In this way the maximum amount of network subscribers in the communication network can be increased.

The invention further relates to a network device embedded in a communication network, wherein the network device comprises a subscriber identifier for addressing the network device over the communication network and wherein the subscriber identifier comprises a number of binary coded decimals, wherein the subscriber identifier comprises the at least one digit, which is a binary coded number of a higher order numbering system than the decimals numbering system. According to the present invention, it is thereby advantageously possible to extend the numbering range of an existing communication network by new subscriber identifiers using at least partly higher order number systems than the decimal number system in order to identify and address certain network subscribers. In particular, the new numbering range is provided on top of the existing, so that the common overall structure of the communication networks can still be used. Preferably, the network device is configured to receive and/or to generate signaling messages comprising the at least one digit. The network device e.g. comprises a conventional telephone having an additional button for the input of the at least one digit by a user. The telephone is able to create and transmit the binary coded number of the higher order numbering system caused by pressing the button for the digit. Furthermore, the network device exemplarily comprising a mobile station which is able to receive, to interpret and to forward an incoming message comprising the at least one digit.

These and other characteristics, features and advantages of the present invention will become apparent from the following detailed description, taken in conjunction with the accompanying drawings, which illustrate, by way of example, the principles of the invention. The description is given for the sake of example only, without limiting the scope of the invention. The reference figures quoted below refer to the attached drawings.

The present invention will be described with respect to particular embodiments and with reference to certain drawings but the invention is not limited thereto but only by the claims. The drawings described are only schematic and are non-limiting. In the drawings, the size of some of the elements may be exaggerated and not drawn on scale for illustrative purposes.

Furthermore, the terms first, second, third and the like in the description and in the claims are used for distinguishing between similar elements and not necessarily for describing a sequential or chronological order. It is to be understood that the terms so used are interchangeable under appropriate circumstances and that the embodiments of the invention described herein are capable of operation in other sequences than described of illustrated herein.

According to embodiments of the present invention, a more efficient utilization of the infrastructure of mobile radio networks is possible, including the situation where a compatibility with an older standard of mobile radio communication has to be assured, e.g., with respect to older mobile devices.

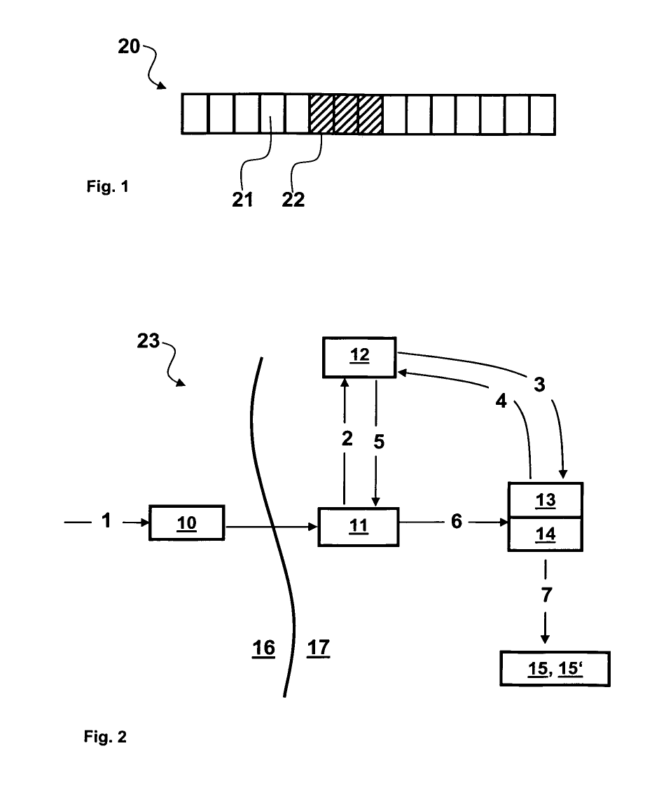

In FIGS. 1 and 2, an exemplary subscriber identifier 20 assigned to a network subscriber 15 of a communication network 23 by an exemplary method according to the present invention is schematically shown. On the left hand, a network element of the caller's network (the so-called ‘A-party network’) is shown.

To provide communication connections between different network subscribers 15 of a communication network 23, each of the network subscribers 15 has to be identifiable and addressable inside the communication network 23. Therefore, a certain subscriber identifier 20 is assigned to each network subscriber 15. In the present example, the communication network 23 comprises a telephone network, wherein the subscriber identifier 20 comprises a telephone number. Common telephone numbers use binary coded decimals 21 on the protocol level. This means that 4 bits are used to code the numbers 0 to 9. However 16 different values would be possible within 4 bits. By changing the number system partly from the decimal system to a higher order system—as a maximum the hexadecimal system, for instance—the unused values can be taken to extend the numbering range. For compatibility reasons with existing protocols and to ease the routing only a subset of the number is extended. In the present case, for certain digits of the number digits 22 are combined with the binary coded decimals 21, giving a binary coded number of a higher order numbering system than the decimals numbering system on the protocol level. The binary coded decimals include values e.g. 0:0000, 1:0001, 2:0010, 3:0011, 4:0100, 5:0101, 6:0110, 7:0111, 8:1000 and 9:1001, wherein the binary coded number of the higher ordering numbering system includes also the additional values 10:1010, 11:1011, 12:1100, 13:1101, 14:1110 or 15:1111 (referred to as numbers A to F in the hexadecimal system), for example. The subscriber identifier is a combination of a number of binary coded decimals 21 with three digits 22 comprising binary coded numbers of the higher order numbering system. After combining the binary coded decimals 21 with the digits representing binary coded numbers of a higher order numbering system than the decimals numbering system, the subscriber identifier 20 is assigned to a network subscriber 15 in a common way, for instance.

A clear advantage of the proposed extension is that a completely new numbering range is provided on top of the existing, which can be used for dedicated purposes, e.g. for machine to machine communication only.

In FIG. 2, an exemplary architecture of a mobile network 23 according to an embodiment of the present invention is schematically shown. In particular, FIG. 2 shows the call setup for a mobile terminated call that was initiated in a different communication network.

Message 1 is an ISUP (ISDN User Part) IAM (Initial Address Message), which contains as parameter the called party address, in particularly the subscriber identifier 20, MSISDN (Mobile Subscriber ISDN) number. The called party is a network subscriber 15, e.g. a network device 15′ like a mobile station or a user equipment. Based on the CC (Country Code) and the NDC (Network Destination Code) of the MSISDN the message is routed over the gateway 10 from the A—party network 16 to the GMSC (Gateway Mobile Switching Center) 11 of the called party's PLMN (Public Land Mobile Network).

A MAP (Mobile Application Part) SRI (Send Routing Information) is sent in message 2 from the GMSC 11 of the HPLMN (Home Public Land Mobile Network 17) to the HLR (Home Location Register) 12 to query the called party's location. The subscriber identifier 20 for the query is the MSISDN.

The HLR 12 searches for the subscriber data of the called party. They contain the IMSI (International Mobile Subscriber Identity) and the current MSC (Mobile Switching Center) area of the called party. IMSIs are represented as binary coded decimals on protocol level. This means that 4 bits are used to code the numbers 0 to 9. However 16 different values would be possible within 4 bits. By changing the number system partly from the decimal system to a higher order system—as a maximum the hexadecimal system, for instance—the unused values can be taken to extend the numbering range. For compatibility reasons with existing protocols and to ease the routing only a subset of the number (i.e. a subset of the digits of the IMSI) is extended, preferably the subset relating to the subscriber number (MSIN, Mobile subscriber identification number). The IMSI is then a combination of a number (especially having 15 digits) of binary coded decimals with some of the digits comprising binary coded numbers of the higher order numbering system.

The HLR 12 requests a MSRN (Mobile Station Roaming Number) from the VLR (Visitor Location Register) 13/MSC (Mobile Switching Center) 14 where the called party is located (message 3). The identifier used in this request is the IMSI. The MSRN has a similar format as an MSISDN, but is only dynamically allocated to enable to route the call to the MSC 14 that is responsible for the called subscriber.

The VLR 13/MSC 14 answers with message 4 (MAP PRN_ack) and provides a MSRN (Mobile Station Roaming Number) to the HLR 12. The MSRN is forwarded to the GMSC 11 in message 5 (MAP SRI_ack).

Now, the call is connected to the MSC 14 that is responsible for the called party by means of a ISUP message 6 (IAM) containing the MSRN as parameter.

Based on the MSRN the VLR 13 is able to find the subscriber data which have been stored during the location update/IMSI (International Mobil Subscriber Identity) attach procedure and to initiate the further call setup via the radio interface. As identifier on the lower radio layers a temporary identifier, the so called TMSI (Temporary Mobile Subscriber Identity) is used.

The subscriber identifier 20 for identifying and addressing the network subscriber 15 comprises a combination of a number of binary coded decimal numbers 21 with three digits 22 representing binary coded numbers of a higher numbering system than the decimals numbering system on the protocol level.

For the example MSISDNs this means the following: In the ISUP messages the calling party number and the called party number are usually BCD values. However some of the values bigger than 9 are used for special purposes and only the binary values 1010, 1101 and 1110 are available (marked as ‘spare’ in the protocol specification) for the called party number. According to the present invention, a combination of numbers 0 to 9 with additional digits A, B and C (with three binary values (especially 1010, 1101, and 1110) additionally used together with the ten conventionally used binary values (especially 0000, 0001, 0010, 0011, 0100, 0101, 0110, 0111, 1000, 1001) are used as the subscriber identifier 20, e.g. as MSISDN. With the CC and NDC remaining in decimal system to be able to keep the existing routing logic across different networks, the full digit range for the subscriber number up to a total length of 15 digits can be used in the extended ranges of additionally using A, B and C. For a typical MSISDN in a European GSM network (e.g. CC=43 for Austria, NDC=676 for T-Mobile Austria, and SN=xxxxxxx, i.e. MSISDN=43 676 xxxxxxx) this means a new range from 43 676 A000000000 to 43 676 CCCCCCCCCC. These are additional 3*13̂9 =31813498119 MSISDNs. This means in such a system the range of the IMSI is the limiting factor. Of course the IMSI range could then also be extended by using the higher order number systems (i.e.: additionally using A, B and C as mentioned above, at least for the MSIN part of the International Mobile Subscriber Identity (IMSI) number. With adaptation of the routing logic optionally also new NDCs or area codes can be used including the values A, B and C.

The MAP messages make use of the addressing format of the SCCP (Signaling Connection Control Part). The coding is similar to the ISUP coding described above; the binary values 1010, 1101 and 1110 are available in the address fields. So the same number range extensions can be used on the MAP.

On the radio interface the calling and called party addresses are coded as BCD numbers. However binary values 1100, 1101 and 1110 are already marked as ‘a’, ‘b’ and ‘c’, value 1010 means ‘*’ (star or asterisk). So either a mapping in the MSC from value 1100 on the radio side to value 1010 on the fixed network side has to be done and vice versa or only the values 1101 and 1110 as part of the subscriber identifier 20 are used. Using only 2 more values (i.e. A and B (with two binary values (especially 1101 and 1110) additionally used together with the ten conventionally used binary values (especially 0000, 0001, 0010, 0011, 0100, 0101, 0110, 0111, 1000, 1001)), for the subscriber number SN still means a number range extension by 2* 12̂9=10319560704. For paging the subscriber on the radio interface either the Temporary Mobile Subscriber Identity (TMSI) is used, a temporary hex-coded number, or if this TMSI is not available, the IMSI is used. On the radio interface layer 3 protocol, the IMSI is BCD coded with the binary values 1010, 1011, 1100 and 1110 being available as spare values. So the same extension as to the calling and called party addresses can be easily applied to the IMSI.

The coding of numbers in messages for sending and receiving short messages is similar to that of numbers in call setup messages within the communication network 23. So the mobile stations would be able to setup and receive calls and to send and receive short messages with the same number range extensions comprising the digit 22 as a part of the subscriber identifier 20. A prerequisite is that the mobile stations are able to dial the new extension numbers and to accept them in incoming signaling messages.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B.” Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise.

1-10. (canceled)

11. A method for using a subscriber identifier for addressing a network subscriber in a communication network, the method comprising:
combining, within the subscriber identifier, a number of binary coded decimals with at least one digit, wherein the at least one digit is a binary coded number of a higher order numbering system than the decimal numbering system.

12. The method according to claim 11, wherein the subscriber identifier comprises a Mobile Subscriber ISDN Number (MSISDN), and wherein the at least one digit is used as a part of a subscriber number (SN) of the MSISDN.

13. The method according to claim 12, wherein the at least one digit is used as a part of at least one of a country code (CC) or a network destination code (NDC) of the MSISDN.

14. The method according to claim 11, wherein the subscriber identifier is used in at least one of a Mobile Application Part (MAP) or an ISDN User Part (ISUP) protocol.

15. The method according to claim 1 wherein a binary coded hexadecimal is used as the at least one digit.

16. The method according to claim 11, wherein a binary code registered as a spare value in the used communication protocol, is used as the at least one digit.

17. The method according to claim 11, wherein the method further comprises:
allocating a different binary coded number of the higher order numbering system to the at least one digit when switching from one communication protocol to another communication protocol.

18. A communication network for establishing circuit switched or packet switched connections between at least two subscribers or between at least one subscriber and at least one service nodes or servers, the communication network comprising:
at least one network subscriber, wherein a subscriber identifier is allocated to the at least one network subscriber and wherein the subscriber identifier comprises a number of binary coded decimals and at least one further digit which is a binary coded number of a higher order numbering system than the decimal numbering system.

19. A network device embedded in a communication network, the network device comprising:
a subscriber identifier for addressing the network device over the communication network, wherein the subscriber identifier comprises a number of binary coded decimals and at least one further digit which is a binary coded number of a higher order numbering system than the decimal numbering system.

20. The network device according to claim 19, wherein the network device is configured to receive signaling messages comprising the at least one further digit.

21. The network device according to claim 19, wherein the network device is configured to generate signaling messages comprising the at least one further digit.
